(19) United States
(12) Patent Application Publication
(10) Pub. No.: US 2025/0106557 A1
(43) Pub. Date: Mar. 27, 2025

(54) IMPEDANCE SWITCHER ARCHITECTURE

(71) Applicant: Steven M. Fryette, Valley Glen, CA (US)

(72) Inventor: Steven M. Fryette, Valley Glen, CA (US)

(21) Appl. No.: 18/893,465

(22) Filed: Sep. 23, 2024

Related U.S. Application Data
(60) Provisional application No. 63/540,085, filed on Sep. 24, 2023.

(51) Int. Cl. H04R 3/12

(52) U.S. Cl. CPC H04R 3/12; H04R 2420/01; H04R 2420/03

(57) ABSTRACT

A program-controlled impedance switcher architecture which facilitates the automatic selection and connection of an amplifier to a cabinet system of equivalent impedance, in a system of multiple amplifiers and multiple cabinet systems. The switcher employs a low-profile matching transformer of multiple primaries and multiple secondaries can be automatically controlled using switching elements to select and connect the impedance devices when an impedance mismatch is detected, or bypass the transformer when an impedance mismatch is not detected. The switcher system can employ multiple inputs and outputs, programmable patches, MIDI® programming control, front panel function controls and indicators, and a matching transformer suitable for accommodating numerous tube amplifier and speaker cabinet impedances and power handling capacities.

### BACKGROUND

A shortcoming of existing guitar amplifier (“amps”) and speaker cabinet systems (“cabs”) is that the user must manually set the amplifier output impedance of any given amplifier employed to match the impedance of the speaker cabinet the user desires to use. Moreover, tube amplifiers require connection to a specific impedance load to operate properly and to avoid damage to the output tubes and transformer.

Today's users can own a wide variety of vintage and modern vacuum tube amplifiers, all of which exhibit lesser or greater degrees of sensitivity to their applied external loads. This is an esoteric operating condition not well understood by the average user, which raises the possibility of damage to expensive, and possibly irreplaceable vintage gear, as well as it is expensive to service modern tube amplifiers.

In order to safely use any of the currently-offered amplifier/cabinet switching systems offered in the marketplace, the user must either, 1) manually set each amplifier to operate correctly into the desired load, or 2) operate a given amplifier or speaker cabinet (load) at a relatively benign mismatch and hopefully avoid potential consequences. If the selected alternate cabinet is not the same impedance as the amplifier connected thereto, for optimum audio quality, the user (e.g., musician) must manually select a switch setting that provides a matched impedance. Moreover, in a complex system involving many amplifiers and cabs/loads, the wiring and electrical connections are all in the rear of the units and are difficult to access, especially when one wants to change quickly to an otherwise incompatible combination.

Thus, in some instances, to avoid user interruption during play and/or performances, the user may even accept the impedance mismatch, rather than stopping play to make the setting change for optimum audio quality. Users and professionals who have complex home, studio, and/or live performance equipment systems seek features unavailable in the marketplace that minimize and even alleviate interruption(s) to the user during setup and performance.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed innovative solution comprises an automatic impedance switching architecture (“switcher”) that facilitates the automatic control and selection of the matching and/or mismatching of input and output device impedances. Thus, multiple amplifiers of differing output impedances can be connected into a variety of speaker loads which may or may not be of like or compatible impedance.

More specifically the disclosed architecture addresses at least a potential impedance mismatch issue in multiple amp/cab implementations by incorporating a matching transformer of sufficient quality, frequency response, and power handling capacity to properly interface virtually any amplifier output to any suitable speaker load, whether the load is a live speaker cabinet system, or a silent reactive load, which is often used for recording purposes.

Additionally, the disclosed architecture eliminates the need to manually set the proper impedance between each amplifier and cabinet (load) by incorporating the matching transformer into a microprocessor-controlled relay switching system. The system can be set once for each desired combination and that setting/combination can be programmed and stored into memory for later recall. The stored memory can be accessed using a Bank/Preset selector on the front panel of the switching unit chassis or controlled remotely using any of the commonly available external MIDI (Musical Instrument Digital Interface®) control devices.

In the case where the chosen amplifier and speaker load are already impedance compatible and do not require the intervention of the matching transformer, but the user still requires the ability to call up such a combination on demand, the disclosed architecture can be preprogrammed internally to bypass the transformer entirely for maximum fidelity and performance. This is accomplished by programming the system to recognize when the input, or primary side of the matching transformer and the output, or secondary side of the transformer, are set to the same value. For example, when the Amplifier (input) and Load (speaker output) are both 16-ohm devices, and the switching system is set to 16 ohms input and 16 ohms output, the system recognizes that there is no mismatch and bypasses the matching transformer automatically. Accordingly, now the user can simply set up the system for every conceivable combination of amplifier and load, and then store the numerous combinations (e.g., up to 128) in non-volatile memory.

The matching transformer, having multiple primaries and secondaries that can be manually selected via front panel switches, or auto-selected (under programmed control) using relays, for example, so the user can enable automatic selection of the input impedance and the output impedance of any and every signal path, if so required, or ignore the transformer entirely when the input/output impedances already match.

The disclosed system employs multiple inputs and outputs, programmable patches, MIDI programming control, front panel function controls, and a matching transformer (e.g., high quality) suitable for accommodating numerous tube amplifier and speaker cabinet impedances and power handling capacities. The matching transformer is of sufficient dimensions to be constructed into a system chassis of one rack space in height (produced by Steven Fryette Design®).

When routing an amplified signal from the amplifier output to a cabinet system through any intermediate device such as a matching transformer or attenuator (e.g., such as a Power Station® produced by Steven Fryette Design®), the intermediate device should at most, if at all, present a minimally perceivable insertion loss and perceived lack of transparency.

To ensure there is minimal, to no, perceived insertion loss in an amplifier/cabinet switcher system which employs a matching transformer, the disclosed signal path routing scheme architecture incorporates a feature that can automatically bypass the matching transformer. This automatic bypass operation can be enabled in at least two circumstances: (1) when the primary and secondary impedances are the same (as occurs when the amplifier and cabinet combination already have an impedance match; and, (2) when the user chooses to enable automatic bypass of the matching transformer to intentionally create a mismatch, which in some cases can be perceived as tonally beneficial.

In addition, one or more of the switcher systems linked above can incorporate an external device loop to allow the user to insert a power attenuator between an amplifier buss and a speaker buss. This capability is a useful feature, and becomes more useful: (1) when the external device loop can be assigned and programmed to operate all the time, or only on a specific signal path between a specific amplifier (“amp”) and cabinet (“cab”), leaving other combinations not attenuated as desired; and, (2) when the attenuator loop is placed ahead of the matching transformer so as not to complicate impedance matching. For example, some attenuators do not offer a selectable impedance feature, so if a user prefers a specific combination, such as an eight (8) ohm amplifier, attenuator, and cabinet, for example, the matching transformer can be made to “stay out of the way”, thus enhancing transparency.

Two additional and unique features which that can be incorporated into the disclosed switcher system architecture, include: (1) a LINK function allows the user to link (electrically interconnect) at least two switcher systems together for operating additional amplifiers (“amps), amplifier heads (“heads), and speaker cabinets (“cabs). (This can be preferrable to buying another larger more expensive unit when all may be needed is a simple and inexpensive unit to add one or two heads or cabs, an attractive option for current owners of existing switchers.); and (2), a second, non-programmable, non-switchable attenuator loop (labeled Loop 1 in the figures) for users who prefer to experiment with various brands/types of attenuators. Many Power Station® owners also own other types of equipment which are sometimes found more applicable to a specific combination of amp and cab, or simply want to use existing equipment.

Further to item (2), a remote-control function is a feature provided that remotely switches an attenuator on and off (e.g., when using a Power Station®). In this way, when using two attenuators, a Power Station® unit can be used in a non-switchable loop, or external to the switcher entirely to operate a specific combination of amp/attenuator/cab, while at the same time using a passive, non-switchable attenuator in the switchable loop for greater flexibility.

More specifically, in one embodiment, there is disclosed an impedance switcher system, comprising: a matching transformer subsystem, the subsystem comprises a matching transformer connected between amplifier outputs of differing output impedances and cabinet loads of differing load impedances, the transformer comprising; multiple primary-side taps where each primary-side tap connects to an amplifier output, which amplifier output has an amplifier output impedance which is different from amplifier output impedances of other amplifier outputs connected to the other primary-side taps; and multiple secondary-side taps where each secondary-side tap connects to a cabinet load, which cabinet load has a cabinet load impedance which is different from other cabinet load impedances of other cabinet loads connected to the other secondary-side taps; and, a control system interfaced to the matching transformer subsystem to detect an impedance mismatch between the amplifier output impedances and cabinet load impedances, and at least one of connects the amplifier output impedances to equivalent load impedances, or bypasses the impedance matching process.

The control subsystem is programmable and can be controlled via software instructions and electromechanical settings. The control subsystem can be controlled via at least one of a MIDI® device. The system can further comprise a link function which enables interconnection and functional control of multiple interconnected impedance switcher systems. The matching transformer is comprised of multiple primary windings and multiple secondary windings, each of the primary windings and multiple secondary windings selectable using the switching elements to map the impedance input to the impedance output so that the output impedance of the input device is compatible with the input impedance of the output device.

The control subsystem enables creation of programmable patches for automatic execution when execution is initiated by the user or other execution triggering event. The transformer subsystem is bypassed when the primary and secondary impedances match. The transformer subsystem can be automatically bypassed (according to executed program instructions) to create an impedance mismatch between the output device and the input device.

The system comprises a switching device which incorporates an external device loop for insertion of a power attenuator between an amplifier buss and an audio speaker buss. The system can further comprise a link function which enables linking together of multiple switcher devices to operate multiple amplifiers with multiple speaker cabinets.

The system can further comprise an attenuator loop link function which enables linking of multiple switcher devices together to operate multiple amplifiers and multiple speaker cabinets. The system can further comprise a remote-control function for wirelessly enabling and disabling at least one of a first attenuator in a switchable loop or a second attenuator in a non-switchable loop.

In yet another embodiment, an impedance switcher system is disclosed and described, comprising: an input for receiving an input signal from an input device, the input device having an output impedance and the input signal switchable to enable connection to at least one of a single or multiple signal pathways to an output, the output for outputting an output signal to an output device, the output device having an input impedance; switching elements positioned between the input and the output to enable switching of the input signal to the output using the at least one of a single or multiple signal pathways; a transformer comprised of multiple primary windings mapped to corresponding primary impedances and multiple secondary windings mapped to corresponding secondary impedances; and, a control subsystem which automatically controls switching elements to enable an impedance match or an impedance mismatch of a signal pathway between the input device relative to the same signal pathway of the output device; an external device loop which enables insertion of an attenuator between an input device and an output device, the external device loop is assignable and programmable for at least one of continuous operation or only on a specific signal path between the input device and the output device.

In still another embodiment, an impedance switcher system is disclosed and described, comprising: a matching transformer subsystem, the subsystem comprises a matching transformer connected between amplifier outputs of differing output impedances and cabinet loads of differing load impedances, the transformer subsystem comprising; multiple primary-side taps where each primary-side tap connects to an amplifier output, which amplifier output has an amplifier output impedance which is different from amplifier output impedances of other amplifier outputs connected to the other primary-side taps; and multiple secondary-side taps where each secondary-side tap connects to a cabinet load, which cabinet load has a cabinet load impedance which is different from other cabinet load impedances of other cabinet loads connected to the other secondary-side taps; and, a control system interfaced to the matching transformer subsystem to detect an impedance mismatch between the amplifier output impedances and cabinet load impedances, and at least one of connects the amplifier output impedances to equivalent load impedances or bypasses the impedance matching process, the control system is programmable and executes software instructions to automatically detect at least one of the impedance equivalences or the impedance mismatches.

The impedance switcher system can further comprise a processor-controlled relay switching subsystem connected to the transformer subsystem to store and execute stored configuration instructions related to detecting input/output device impedance mismatch and input/output device impedance equivalences. The impedance switcher system can further comprise an external device loop which enables insertion of a power attenuator between an amplifier buss and a speaker buss, the external device loop is assignable and programmable for continuous operation or only on a specific signal path between an amplifier and a speaker cabinet, wherein the external device loop enables use of an attenuator on a specific signal path which avoids the transformer subsystem.

The impedance switcher system can further comprise a remote-control function which enables switching power on and off to the attenuator of the external device loop. The control system is configured to execute Bluetooth wired and wireless control protocols and -MIDI wired and wireless control protocols.

In yet another embodiment, there is disclosed an audio signal interconnection subsystem electrically connected between power amplifiers and speakers to conduct musical instrument signals from the power amplifiers to the speakers, the power amplifiers have output impedances and the speakers have input impedances; a transformer subsystem of primary-side taps and secondary-side taps, the primary-side taps electrically connect to respective amplifier outputs of the power amplifiers and the secondary-side taps electrically connect to respective speaker inputs of the speakers, the amplifier outputs each have different amplifier output impedances and the speaker inputs each have different speaker input impedances; and a control system electrically interfaced to the transformer subsystem to detect an impedance mismatch between an amplifier output impedance and speaker load impedance, and in response, at least one of connects the amplifier output impedances to an equivalent load impedance or bypasses the impedance matching process.

In still another embodiment, there is disclosed an impedance switcher system, comprising: an audio signal interconnection subsystem electrically connected between power amplifiers and speakers to conduct musical instrument signals from the power amplifiers to the speakers, the power amplifiers have output impedances and the speakers have input impedances; a transformer subsystem of primary-side taps and secondary-side taps, the primary-side taps electrically connect to respective amplifier outputs of the power amplifiers and the secondary-side taps electrically connect to respective speaker inputs of the speakers, the amplifier outputs each have different amplifier output impedances and the speaker inputs each have different speaker input impedances; and a control system electrically interfaced to the transformer subsystem to detect an impedance mismatch between an amplifier output impedance and speaker load impedance, and in response, at least one of connects the amplifier output impedances to an equivalent load impedance or bypasses the impedance matching process, the control system activates switching elements to perform routing and impedance matching tasks according to combinations of at least one of user-selected control switch settings or system-detected control switch settings stored in non-volatile memory.

In yet another embodiment there is disclosed an impedance switcher system, comprising: a matching transformer subsystem, the subsystem comprising a matching transformer connected between amplifier outputs of differing output impedances and cabinet loads of differing load impedances, the transformer subsystem comprising; multiple primary-side taps where each primary-side tap connects to an amplifier output, which amplifier output has an amplifier output impedance which is different from amplifier output impedances of other amplifier outputs connected to the other primary-side taps; and multiple secondary-side taps where each secondary-side tap connects to a cabinet load, which cabinet load has a cabinet load impedance which is different from other cabinet load impedances of other cabinet loads connected to the other secondary-side taps; and a control system electrically interfaced to the transformer subsystem to detect an impedance mismatch between an amplifier output impedance and speaker load impedance, and in response, at least one of connects the amplifier output impedances to an equivalent load impedance or bypasses the impedance matching process, the control system activates switching elements to perform routing and impedance matching tasks according to combinations of at least one of user-selected control switch settings or system-detected control switch settings stored in non-volatile memory.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates an automatic impedance switcher system in accordance with the disclosed architecture.

FIG. 2 illustrates a more detailed block diagram of an automatic impedance switcher system in accordance with the disclosed architecture.

FIG. 3 illustrates an alternative depiction of an automatic impedance switching system in accordance with similarities of the other disclosed embodiments.

FIG. 4 illustrates a circuit diagram of the signal input, amplifier input select, and external switcher SEND output of the disclosed switcher architecture.

FIG. 5 illustrates a circuit diagram of amplifier outputs select and external switcher return of the disclosed switcher architecture.

FIG. 6 illustrates a circuit diagram of the automatic impedance matching subsystem in accordance with the disclosed architecture.

FIG. 7 illustrates a circuit diagram as relates to speaker cabinet inputs in accordance with the disclosed architecture.

FIG. 8 illustrates a circuit diagram as relates to the switched and unswitched attenuator loop circuits in accordance with the disclosed architecture.

FIG. 9 illustrates a circuit diagram for a wireless remote capability for automatic impedance switching in accordance with the disclosed architecture.

FIG. 10 illustrates additional circuits that can be employed in accordance with the disclosed architecture.

FIG. 11 illustrates additional circuits that can be employed for LED indicator control in accordance with the disclosed architecture.

FIG. 12 illustrates a configuration of the flatpack matching transformer in accordance with the disclosed architecture.

FIG. 13 illustrates a front panel configuration of the housing that encloses the impedance switcher in accordance with the disclosed architecture.

### DETAILED DESCRIPTION

The disclosed architecture defines improvements in the area of component design which not only meet the needs of a wide variety of users, but also the most discerning musicians who have the ability to audibly detect the slightest tonal degradations.

The disclosed architecture addresses at least an impedance mismatch issue between amplifiers (also referred to as outputs) and speaker loads (inputs) by incorporating a matching transformer of sufficient quality, frequency response, and power handling capacity to properly interface virtually any amplifier output to any suitable speaker load, whether the load is a live speaker cabinet system, or a silent reactive load, which is often used for recording purposes.

In the cases where the chosen amplifier and speaker load are already compatible and do not require the intervention of the matching transformer, but the user still requires the ability to call up such a combination on demand, the system can be preprogrammed internally to bypass the transformer entirely for maximum fidelity and performance. This is accomplished by programming the system to recognize when the input, or primary side of the matching transformer and the output, or secondary side of the transformer are set to the same value. For example, when the Amplifier (input) and Load (speaker output) are both 16-ohm devices, and the switching system is set to 16 ohms input and 16 ohms output, the system recognizes that there is no mismatch and bypasses the matching transformer automatically.

Amplifier feedback is a means to help linearize the frequency response of a given amplifier. As it is applied, a small amount of the amplifier output is fed back into the amplifier input. How much is to be fed back depends on how much correction is needed or desired.

As applied to vacuum tube amplifiers, there can be a fine line between too little and too much applied negative feedback because there are usually many fluctuating variables to account for in determining what exactly needs “fixing”. Firstly, it can be easier and less costly to apply negative feedback in vacuum tube amplifiers to correct common weaknesses in output transformer performance. Due to the expense of even an average quality output transformer, the alternative to spending more time and money developing a better transformer design can be more applied negative feedback.

Secondly, current production vacuum tube manufacturers may often publish certain unreliable design parameters in the name of “improved performance” where the improvement is simply a change in the design driven by the desire to cut costs or to substitute more readily available raw materials. This problem may be compounded by a vacuum tube amplifier manufacturer's lack of experience in power amp design resulting in somewhat arbitrary modifications to the feedback network.

In evaluating the somewhat less than predictable new vacuum tube performance in an amplifier topology that originated in the early to mid-1900s, unexpectedly good or bad outcomes will be encountered, requiring novel solutions to manage these effects, such as amplifier feedback.

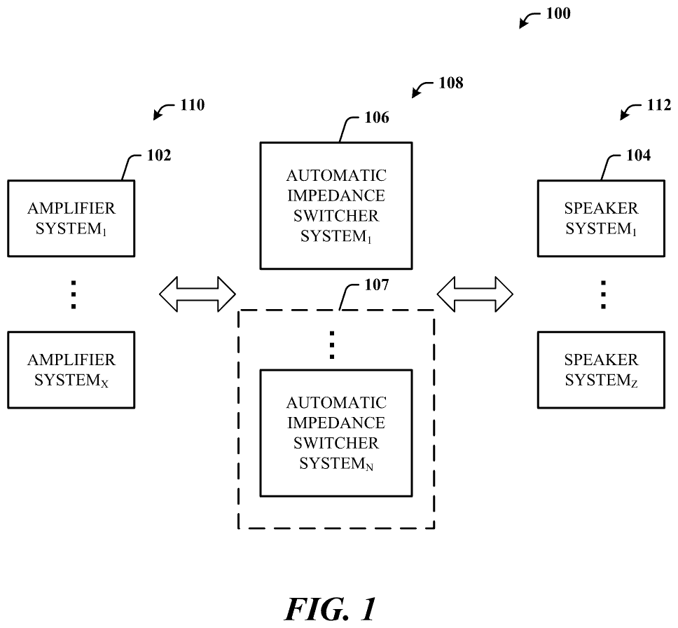

FIG. 1 illustrates an automatic impedance switcher system 100 in accordance with the disclosed architecture. The system 100, in one embodiment, operates with an amplifier system 102 and a speaker system 104 typically employed with a musical instrument such as a guitar (not shown) as the device which inputs signals into the amplifier system 102 and then into a single switcher system 106, and outputs to the speaker system 104 (or systems 112). In an alternative arrangement, the system 100 can employ multiple switcher systems 108 (shown using multiple switcher systems 107 as well, with switcher system 106).

In limited conventional arrangements, the user must then ensure the amplifier impedance and speaker impedance match for optimum tonal (signal) quality, and then manually adjust one or more switches in an interstitial impedance system (not shown) to ensure the impedances match.

However, in contrast to conventional system limitations, the disclosed switcher architecture is an automatic impedance switcher system 106 employed between the amplifier system 102 and the speaker system 104 (or any multiple systems where impedance matching is desired). The switcher system 106 improves on existing switching systems by operating to automatically select internal switching elements to define (create) a signal pathway from the amplifier system 102 to the speaker system 104, which signal pathway enables impedance matching between the amplifier system 102 and speaker system 104. Thus, the user no longer needs to manually intercede to turn switches to achieve the desired impedance matching.

In other words, all that needs to be performed is the user connects the amplifier system 102 and the speaker system 104 to the automated switcher system 106, and the automatic switcher system 106 automatically operates to create a signal pathway for optimal impedance matching (or even mismatching) between the amplifier system 102 and the speaker system 104. Accordingly, users who have complex home, studio, and/or live performance equipment systems no longer need to manually adjust switches, the process which in existing systems requires one or more interruptions to the user during setup and performance.

In a more complex arrangement, it is within contemplation of the disclosed switcher system 100 that multiple switcher systems_{1-N} 108 can be utilized with multiple amplifier systems_{1-X} 110 and multiple speaker systems_{1-Z} 112. For example, a switcher system₁ can be operated in a daisy-chained fashion such that an output of switcher system can be connected to an input to a switcher system₂, and an output of switcher system₂ can have an input to a switch system₃, and so on.

Additionally, each of the switcher systems 108 (e.g., switcher systems₁₋₃) can output a signal to one or more connected speaker systems 112. For example, a first speaker system₁ can be connected to an output of the first switcher system₁, a second speaker system₂ can be connected to an output of a second switcher system₂, a third speaker system₃ can be connected to an output of a third switcher system₃, and so on. In this way, the user can control switcher systems₁₋₃ to automatically engage selected amplifiers and speaker systems for given musical instruments, which can be of differing impedances.

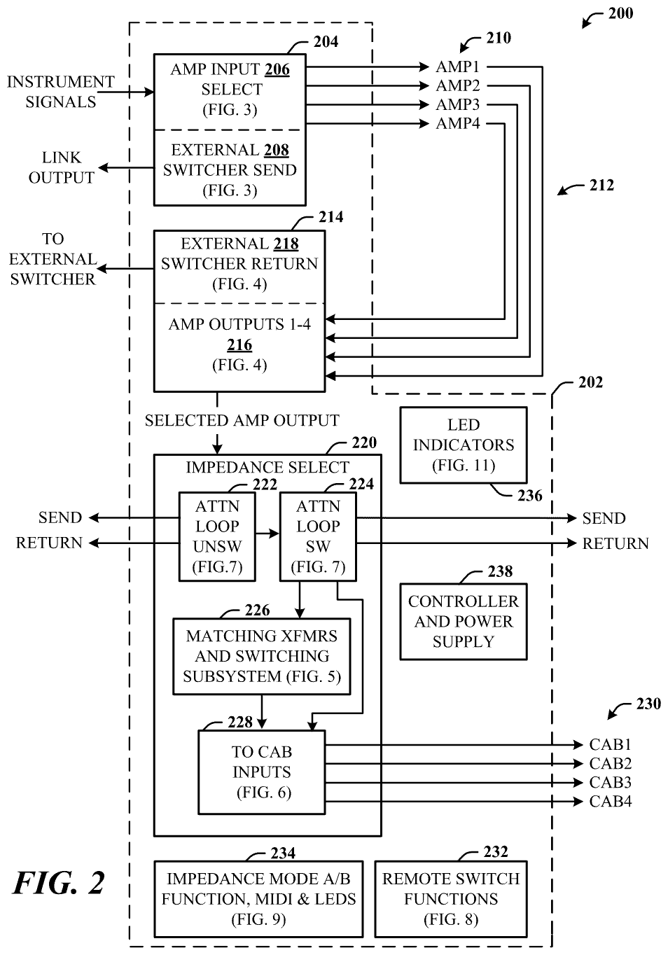

FIG. 2 illustrates a more detailed diagram of an automatic impedance switcher system 200 in accordance with the disclosed switcher architecture. The system 200 comprises a housing 202 in and/or on which are mounted a circuit board, switches, indicators (e.g., LED lights), suitable connectors, circuit elements (e.g., diodes, resistors, capacitors, etc.), solid state devices (e.g., amplifiers, microelectronics chips, controller chips, relays, etc.), and/or electromechanical devices (e.g., relays), a matching transformer, a power source (e.g., a power module), wired and/or wireless communications modules (e.g., for remote control, wireless signal communications, etc.), and a controller section (e.g., a micro-controller).

Other devices and components can be included as well for additional functionality, such as for example, a cooling fan, wired network connectors, Universal Serial Bus (USB) connectivity, onboard storage (e.g., for settings, and executable software storage), etc.

Generally, disclosed herein is an automatic impedance switching architecture (“switcher”) that facilitates the automatic control and selection of matching and/or mismatching of device impedances. The switcher utilizes a matching transformer having multiple primaries and secondaries that can be auto-selected using relays, for example, so the user can enable automatic selection of the input and output impedances of any and every signal path.

The disclosed system employs multiple inputs and outputs, programmable patches, MIDI (Musical Instrument Digital Interface®) and Bluetooth® programming control, front panel function controls, and a matching transformer (e.g., high quality) suitable for accommodating numerous tube amplifier and speaker cabinet impedances and power handling capacities. The matching transformer is of sufficient dimensions to be constructed into a system chassis of one rack space in height.

When routing an amplified signal from the amplifier output to a cabinet system through any intermediate device such as a matching transformer or attenuator, the intermediate device should at most, if at all, present a minimally perceivable insertion loss and perceived lack of transparency.

To ensure there is minimal, to no, perceived insertion loss in an amplifier/cabinet switcher system which employs a matching transformer, the disclosed signal path routing scheme architecture incorporates a feature that can automatically bypass the matching transformer. This automatic bypass operation can be enabled in at least two circumstances: (1) when the primary and secondary impedances are the same (as occurs when the amplifier and cabinet combination already have an impedance match; and, (2) when the user chooses to enable automatic bypass of the matching transformer to intentionally create a mismatch, which in some cases can be perceived as tonally beneficial.

In addition, one or more of the switcher systems linked above can incorporate an external device loop to allow the user to insert a power attenuator between an amplifier buss and a speaker buss. This capability is a useful feature, and becomes more useful: (1) when the external device loop can be assigned and programmed to operate all the time, or only on a specific signal path between a specific amplifier (“amp”) and cabinet (“cab”), leaving other combinations not attenuated as desired; and, (2) when the attenuator loop is placed ahead of the matching transformer so as not to complicate impedance matching. For example, some attenuators do not offer a selectable impedance feature, so if a user prefers a specific combination, such as an eight (8) ohm amplifier, attenuator, and cabinet, for example, the matching transformer can be made to “stay out of the way”, thus enhancing transparency.

Additional and unique features which that can be incorporated into the disclosed switcher system architecture, include: (1) a LINK function allows the user to link (electrically interconnect) at least two switcher systems together for operating additional amplifiers, amplifier heads (“heads), and speaker cabinets; and (2), a second, non-programmable, non-switchable attenuator loop (labeled Loop 1 in the figures) for users who prefer to experiment with various brands/types of attenuators.

Further to item (2), a remote-control function is a feature provided that remotely switches an attenuator on and off. In this way, when using two attenuators, a unit can be used in a non-switchable loop, or external to the switcher entirely to operate a specific combination of amp/attenuator/cab, while at the same time using a passive, non-switchable attenuator in the switchable loop for greater flexibility.

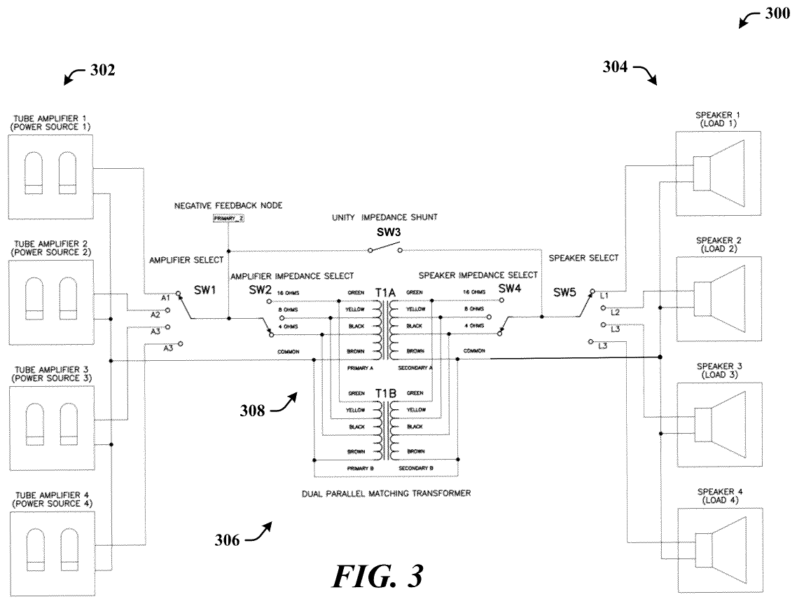

In operation, the system 200 receives instrument signals from a musical instrument into a block 204 of circuitry and components. Block 204 includes an “amplifier input select” subsection 206 (example details of which are described in FIG. 3) and an external switcher SEND subsection 208 (example details of which are described in FIG. 3). It is to be appreciated that “input select” here is the instrument signals input to the Block 204, and can also be referred to amplifier output select when referring to impedance matching the amplifier output to the speaker load (or speaker input).

The signals are received into an amplifier input select subsection 206, which subsection 206 can be designed to route the signals through corresponding connections to any of four external amplifiers 210 (e.g., AMP1, AMP2, AMP3, and AMP4). These amplifiers can be standalone amplifier chassis, for example. Additionally, the signals can be routed to the external switcher SEND subsection 208 and out of the housing 202 to “link” to another switcher system. This output can also be labeled as the LINK OUTPUT.

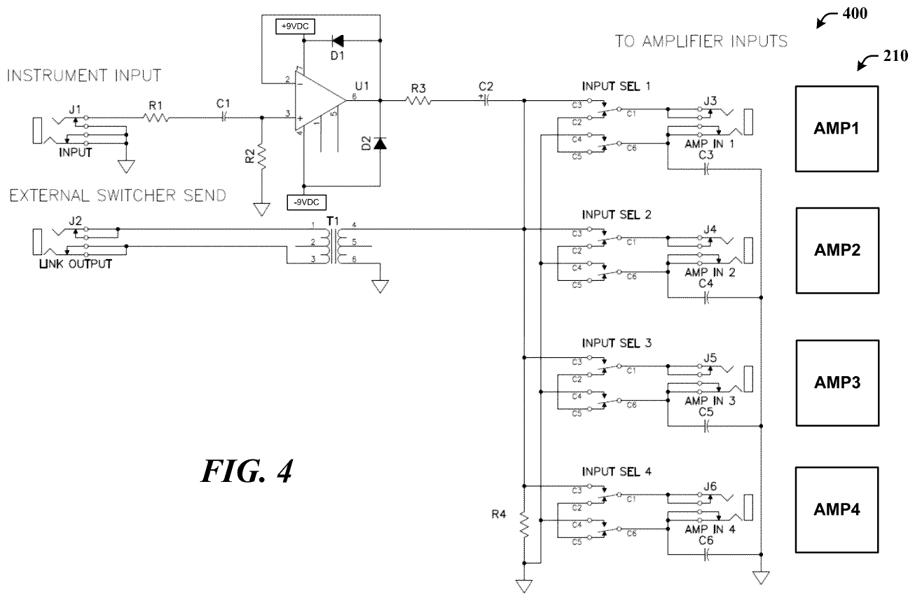

The output(s) 212 of any one or more of the four amplifiers 210 is/are routed to a block 214 of circuitry and components. Block 214 includes an amplifier outputs subsection 216 (example details of which are described in FIG. 4, and which receives the outputs 212 of the amplifiers 210) and an external switcher RETURN subsection 218 (example details of which are described in FIG. 4). The switcher RETURN subsection 218 facilitates a RETURN signal to an external switcher, when utilized.

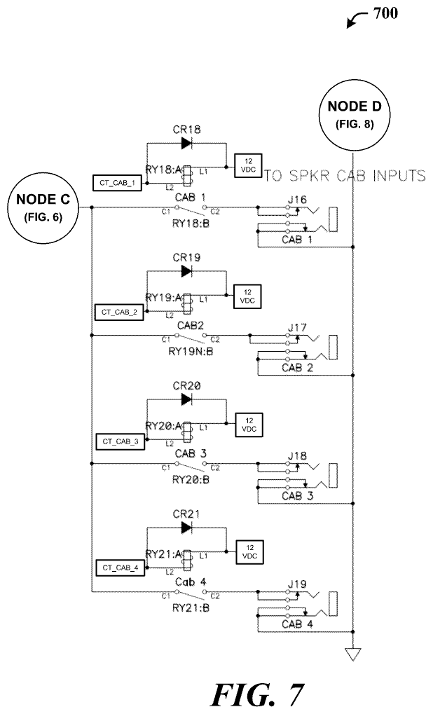

In a four-amplifier system, the four selection output circuits of block 216, which correspond to the four amplifier outputs 212, connect to corresponding inputs in an impedance select block 220. Given that a single amplifier output, of the outputs 212, is selected for impedance matching, this selected amplifier output can then be controlled to connect either to an unswitched attenuator loop circuit 222 (example details of which are described in FIG. 7) or to a switched attenuator loop 224 (example details of which are described in FIG. 7). The unswitched attenuator loop circuit 222 can be accessed for a SEND signal or a RETURN signal. Similarly, the switched attenuator loop 224 can be accessed for a SEND signal or a RETURN signal.

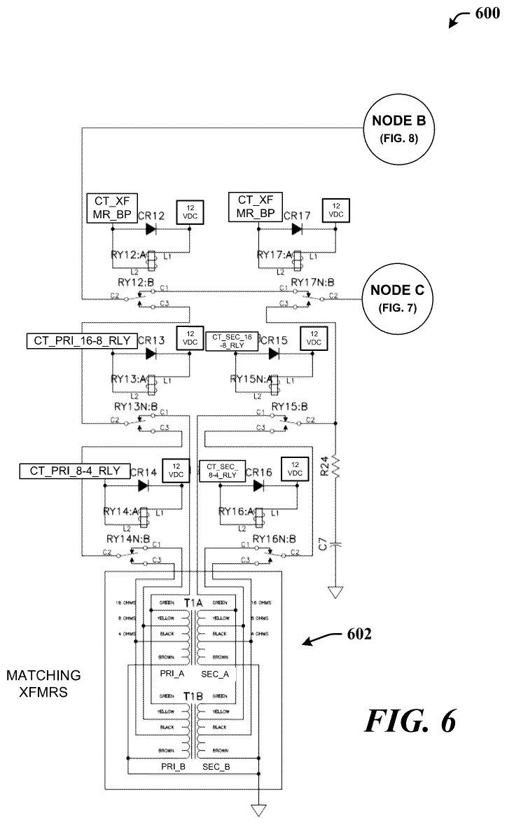

The unswitched attenuator loop circuit 222 can be controlled (“programmed”) to bypass the switched attenuator loop 224 or to select (“programmed”) the switched attenuator loop 224. The unswitched attenuator loop circuit 222 is an external device loop which enables a user to insert a power attenuator between the amplifier buss and the speaker buss. The unswitched attenuator loop circuit 222 is placed ahead of the matching transformer and switching subsystem 226 (example details of which are described in FIG. 6) so as to not impact the automatic impedance matching function.

The impedance select block 220 can also be described as including a block 228 which completes a signal pathway to one of the four speaker cabinets 230 selected to match the impedance of a previously utilized amplifier connected to the system 200.

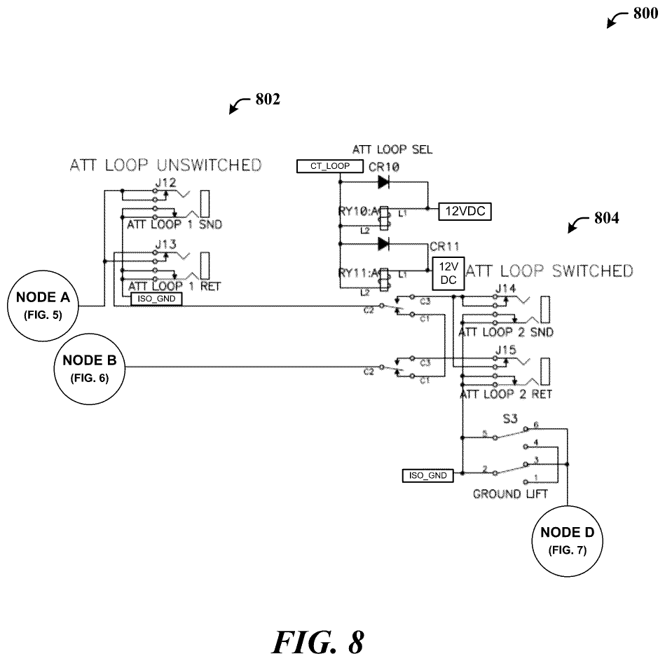

The system 200 can further comprise a block 232 (example details of which are described in FIG. 8) which enables remote switch function controls such as to remotely (e.g., wirelessly) power the system 200 on or off. In this way, when using two attenuators, a power system can be used in a non-switchable loop, or external to the switcher entirely to operate a specific combination of amp/attenuator/cab, while at the same time using a passive, non-switchable attenuator in the switchable loop for greater flexibility.

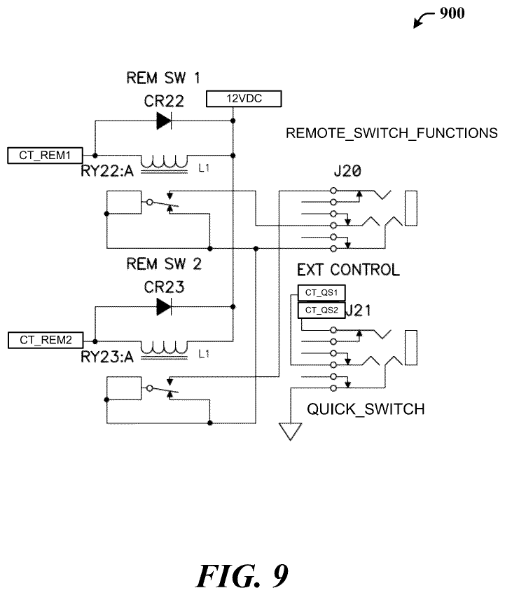

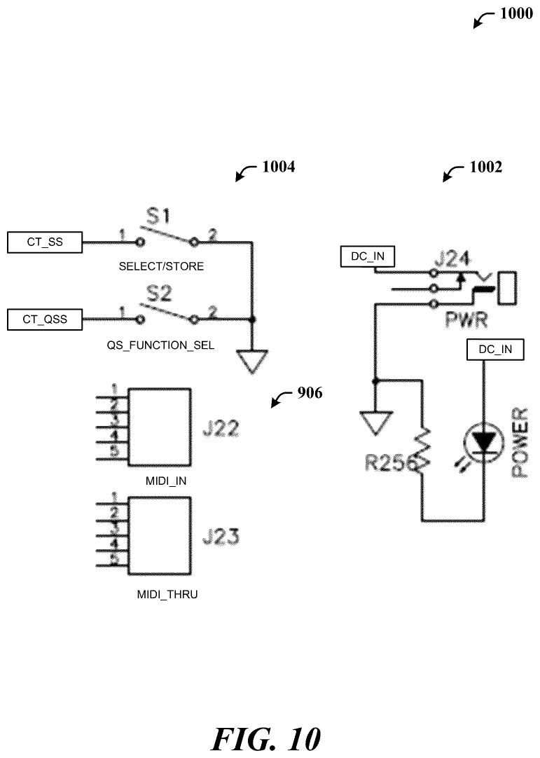

The system 200 can further comprise a block 234 (example details of which are described in FIG. 9) which enables an impedance mode A/B function, MIDI functionality, LEDs controlled for functionality indications, USB connectivity, Bluetooth functionality, and other desired capabilities. The system 200 can further comprise a block 236 (example details of which are described in FIG. 10) which show the utilization of many LED indicators for the different results and switching functions occurring in the system 200. The system 200 can further comprise a block 238 which can comprise a power supply suitable to provide sufficient clean power to operate the onboard mechanical and/or solid-state devices. This block 238 can also include a controller (or micro-controller) programmed and/or programmable with software instructions to enable all onboard functions, remote functions (wired and/or wireless communications), switching controls, etc.

FIG. 3 illustrates an alternative depiction of an automatic impedance switching system 300 in accordance with similarities of the other disclosed embodiments. In this depiction, zero, one, or multiple power sources (“amps” PS1-PS4) here represented as tube (analog) amplifiers, can be digital amplifiers 302, or any combination thereof, can be automatically connected to zero, one, or multiple speaker loads (Load1-Load4) 304 by way of controlling the interstitial switching system 306 (of dual parallel matching transformers T1A and T1B, switches 308, controller (not shown), etc.) by a processor, controller, and/or micro-controller to automatically align the impedances of the amplifiers 302 to the speaker loads 304. Optionally, as provided via the switcher system, the user can manually make the settings adjustments, as well.

System 300 illustrates the selection of one (or more) of four tube amplifiers (similar to amplifiers 210 of FIG. 2) of a particularly desirable sound quality and feature set to be interfaced with one of four speaker loads (also “load systems” 304) of like desirable capabilities. Each of the four amplifiers 302 can be assumed to be set to a desired output impedance (if such capability is provided on the selected amplifier), or operates at a specific output impedance that is not user selectable.

Each of the four speaker systems 304 (Speakers, also, Load 1, Load 2, Load 3, and Load 4) are assumed to operate at a set specific impedance, such as 4, 8, or 16 ohms, as most such speaker systems lack the means for manual or automatic adjustment of the load impedance. Switches SW1, SW2, SW3, SW4, and SW5 can be processor-controlled (e.g., by the controller in block 238 of FIG. 2) switching devices (e.g., microprocessor-controlled relays, and/or manually selectable switches which can be manually selected to override the processor-controlled switch selection, etc.) which are activated to perform the required routing and impedance matching tasks according to the desired combinations of control switches selected by the user and stored in memory (e.g., volatile and/or non-volatile) within the switching system 300 (not shown, but similar to the controller/microcontroller in block 238 of FIG. 2).

As defined herein, the process of “impedance matching” can include the process of identifying the precise integer values (e.g., 4, 8, 16, etc.) of the power source impedance and the speaker impedance to determine if the respective impedances “match”. This definition also comprises a process whereby the user chooses a special tonal effect that can be generated by some degree of impedance mismatch between the speaker and the power source. These results and the associated hardware settings, can be saved in memory for storage and retrieval for automatic and/or manual implementations.

In yet another aspect, the stored settings can be linked, in software, to the specific pieces of musical instruments, amplifiers, and speakers, such that once connected and activated, the software can automatically execute to perform a setup of the overall system based on the specific pieces of equipment. In another aspect, the user simply activates a signal (e.g., setup signal) that then further executes software to configure the systems to desired sound effects, whether impedance matches, is slightly mismatched, or significantly mismatched, etc., based on the music, venue, instruments, etc.

In the event that a selected amplifier output impedance is already compatible with the selected speaker system, the associated impedance selectors will match. In this case, the microprocessor controller software detects the similar routing and matching switch settings, and can close the UNITY IMPEDANCE SHUNT switch SW3, effectively bypassing the dual parallel matching transformer subsystem 308.

In this example, Power Source 1 (PS1) is matched to speaker Load 1, since the amp and cab impedances are determined to match (at 4 ohms). In other words, the desired speaker system is connected directly to the amplifier output whereupon the electro-mechanical behavior of the speaker Load 1 is fed into the amplifier through back-EMF (back-electromotive force), whereupon the behavior of the amplifier (PS1) will be acted upon according to the behavior of a fixed or user adjustable negative feedback loop inside the amplifier PS1.

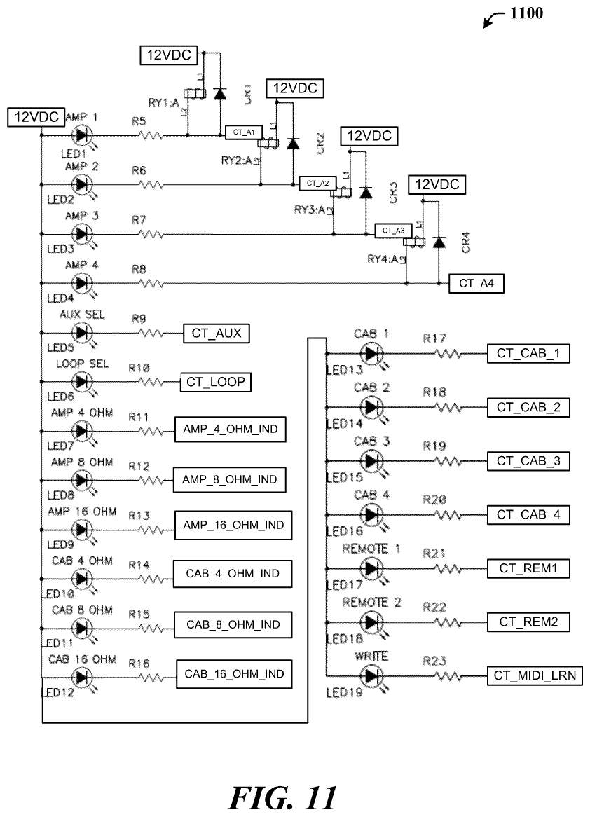

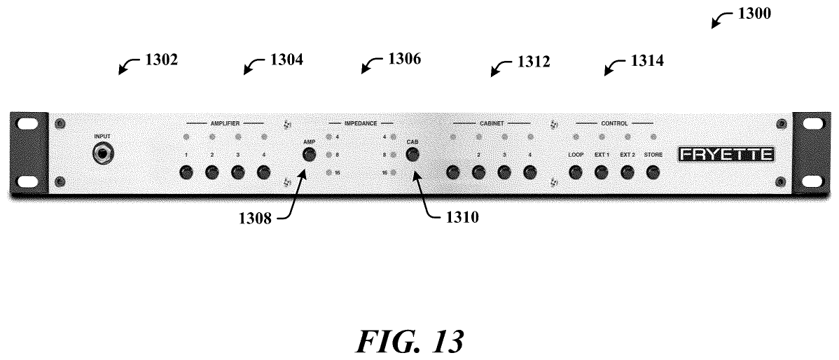

In the event that the impedances of amplifier PS1 and speaker 2 (Load 2) are set differently as can be indicated on (or which can be manually set via the housing), via the front panel housing of the switcher system (sec., e.g., the front panel of system 1300 of FIG. 13), the controller (processor) can detect the difference in switch settings and route the amplifier signal through the matching transformer subsystem 306 (similar to matching transformer(s) 226 of FIG. 2 and transformer 1100 of FIG. 11) accordingly.

Continuing with this latest example, the desired speaker system Load 2 is connected indirectly to the amplifier output via the matching transformers 308, thereby transmitting the electro-mechanical behavior of the speaker Load 2 and the associated back-EMF via the matching transformers 308 to the amplifier PS1 output, whereupon the now altered behavior of the amplifier PS1 will be acted upon according to the new desirable reaction of the fixed and/or user adjustable negative feedback loop inside the amplifier.

In this way, the switcher system (the interstitial system 306) can store, and thereafter retrieve, the desired combinations of the various amps and cabs (speakers), settings for the specific amp/cab combinations, as well as the source and load impedance(s) required for safe operation of the selected amp and cab, and along with the new desirable performance parameters.

Another capability is available in the event that the amplifier PS1 and speaker Load 1 impedance settings are the same, but the amplifier PS1 performance is less than desirable when connected to a particular speaker. In this scenario, the controller again detects that the switch settings are the same and would normally close the shunt switch SW3. However, processor instructions can be incorporated into the software that when executed enable the operator the ability to override the shunt circuit and allow the signal to flow through the matching transformers 308 and to the desired load(s).

This additional and heretofore unavailable feature in the marketplace, recognizes certain properties of amplifier topology and outputs transformer behaviors that are desirable in the art of vacuum tube power amplifier and output transformer design.

In this scenario, an outcome (output tonal characteristics) is often caused by the reduction of back-EMF between a particular amplifier and speaker system. This can be the result of connection to a speaker with a larger magnet assembly (a “motor” described as comprising the magnet assembly and the electromagnetic (or voice) coil)) or an amplifier of lower output power driving a speaker with a smaller than normal motor assembly.

The ability of the amplifier to react to a greater or lesser amount of back-EMF, stems from the amount of negative feedback employed in the amplifier topology. For example, an amplifier with high negative feedback might be less “forgiving” of a speaker with a smaller motor or lower sensitivity. In effect, the amplifier will tend to force the speaker into a comparatively “stiff” behavior pattern. While this may be desirable in high fidelity audio systems, it can be a trait shunned by musicians (e.g., guitarists). Conversely, an amplifier with low or no negative feedback will be more sensitive to a speaker with a larger motor or high sensitivity.

In either case, the relationship between the amplifier and speaker operating parameters can produce excess low frequency response or a brittle metallic high-end response that users appreciate differently. In such cases, additional hysteresis can be induced into the system (in the case of an overly sensitive speaker), or even an intentional impedance mismatch (in the case of a low sensitivity speaker connected to an amplifier with relatively high negative feedback). For example, an 8-ohm amplifier with a low damping factor can be made to “loosen up” when driving a 16-ohm speaker with a small magnet, thereby giving the impression of a fuller and more robust low-end response in a speaker that might normally excel in the midrange.

Amplifier feedback is a means to assist in the linearization the frequency response of a given amplifier. As it is applied, a small amount of the amplifier output is fed back into the amplifier input. How much is to be fed back depends on how much correction is needed or desired.

The tonal and output behaviors herein are understood to be dependent on the various possible loads connected to the amplifier and will be audibly altered when the load impedance changes, even though the amplifiers impedance selector is set to accommodate the new load impedance.

Further, an audibly detectable change can occur if the cable connecting the amplifier to the speaker system increases significantly in length. This is due to the accumulated resistance and capacitance of the cable which can alter the behavior of the feedback circuit.

It is to be appreciated that existing switching systems in the marketplace are placed between the amplifier and the intended load. In actual practice, however, an aspect that is most commonly overlooked is the means of connecting the system elements together—the speaker cables. A typical speaker cable length between an amplifier and speaker system is on the order of approximately three (3) feet. When a switching system is introduced into an amp/cab system, the distance from the amplifier to the switching system and then back to wherever the speaker load is located, can oftentimes result in a total cable distance of on the order of twenty to thirty feet. Existing switching systems cannot account for, or solve the problem of, accumulated cable capacitance and resistance, along with the attendant negative impact on the system sound.

It can be seen that where the input of the negative feedback loop terminates at the speaker output connection to the amplifier, there can be an excessively long speaker cable effect that not only adds capacitance and resistance across the load, but will significantly diminish the back-EMF originating from the speaker system, thereby reducing its influence on the amplifier behavior. The result can be a more “dull” and less dynamically responsive sound.

It can also be seen that the negative-feedback node (Primary_2) is effectively the input to the impedance matching transformers 308. In FIG. 3, in addition to performing the desired impedance alignment (or “correction”), it can be seen that the matching transformer subsystem 308 acts as a “relay station” for the transmission of back-EMF to the amplifier, and serves to isolate the amplifier output node (e.g., node A1) from the negative effects of excessively long speaker cables.

Ultimately, the user is afforded the opportunity to idealize the interplay between a wide variety and number of vintage and modern amplifier and speaker systems with little concern for the negative effects of gross impedance mismatching that occurs in conventional equipment. More specifically, the depicted transformer topology provides a smooth and relatively flat transfer characteristic over most of its general operating range. However, at very low volume levels, the topology exhibits a gentle enhancement of the back EMF effect due to its own inductance. When pushed into the upper range of its power transfer capacity, the topology exhibits a particular flux-leakage characteristic that induces a subtle amount of hysteresis, similar to a “magnetic compression” which tends to enhance the behavior of amplifiers with medium to high levels of negative feedback.

In other words, the disclosed switcher architecture, in the least, is a means of impedance correction (“alignment”) in a typical commercial audio distribution scheme, and a system that enables the relational impacts of electromechanical behavior of a speaker, and the dynamic response of the nature of applied negative feedback in many vintage and modern vacuum tube amplifiers, together with the unique behavior of the unusual output transformer topology. Thia enables the user to introduce or restrict the effects of hysteresis in a given amplifier/speaker combination to produce additional flexibility and control options not previously available.

FIG. 4 illustrates a circuit diagram 400 of block 204 of FIG. 2 of the disclosed switcher architecture. The instrument input signals can be processed through a connector J1 to an operational amplifier (“op-amp”) configured for high input impedance, low noise, and low harmonic distortion, for audio amplifiers and preamplifiers, for example.

In this particular implementation, the “Instrument Input” signals are processed through and from the op-amp to each of four input select connections (INPUT SEL₁₋₄). In other words, the circuit diagram 300 receives instrument signals from a musical instrument, and enables availability of the musical signals to one or more amplifiers (AMP-1 . . . . AMP-4) connected to physical output connection receptacles J3-J6. When a jack of an amplifier cable is plugged into an output connection J3-J6, the mechanical connection of the jack inserted therein not only makes the signals available to the connected amplifiers, but also to the Link Output connector via the isolation transformer T1.

The mechanical jacks (or connections) are each associated with corresponding physical output connections J3-J6, which output connections can individually form part of a signal pathway ultimately defined through the system 100 (e.g., amps, heads, etc.) to an output device, such as a speaker system(s), for example.

The External Switcher Send output connection J2 enables the communication of instrument signals to another switcher system via an isolation transformer T1 to activate switching elements to other output devices such as speaker systems. Note that the “To Amplifier Inputs” nomenclature of diagram 400 can also be referred to as the outputs of the diagram 400, which outputs can be the inputs to the following amplifiers.

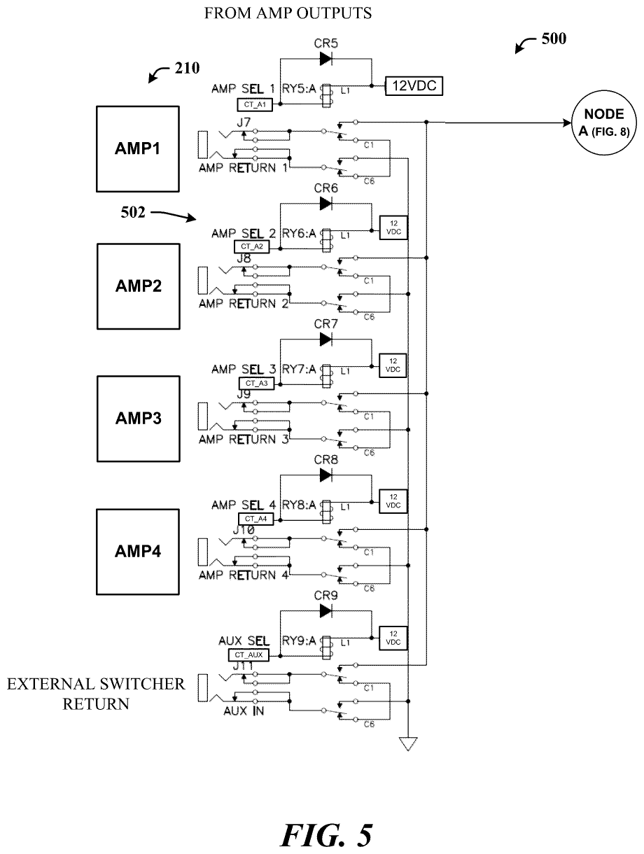

FIG. 5 illustrates a circuit diagram 500 of block 214 of FIG. 2 of the disclosed switcher architecture. Here, the outputs (AMP1, AMP2, AMP3, AMP4) of any of amplifiers up to four, can be plugged into the connector receptacles J7-J10. Additionally, an auxiliary connection via connector receptacle J11 enables an External Switcher Return signal to a second automatic switcher system (not shown).

Each connector receptacle subsystem 502 (e.g., J7-J11) comprises a solenoid which can be enabled according to a control line or control terminal (CT_A1, CT_A2, CT_A3, CT_A4, and CT_AUX) can be operated (controlled) using associated solenoids RY5: A-RY9: A. These switching elements can be electromechanical relays and/or sold-state relays. In operation, when control line (or terminal) (e.g., CT_A2) goes to a lower voltage than 12 VDC, the solenoid is activated, causing relay wipers associated with C1 and C6 to toggle, and sending the associated amplifier (AMP2) output to take the pathway to Node A of the diagram 800 of FIG. 8. Examples of possible hardware part numbers for switching elements RY5-RY9 can be G2RL-2-DC12 @ 2.82/500 DPDT NO 8A relays, for example.

FIG. 6 illustrates an automatic impedance matching subsystem 600 in accordance with the disclosed architecture. The subsystem 600 (similar to block 226 of FIG. 2) includes a dual parallel matching transformers subsystem 602 having multiple primary and secondary winding taps. The multiple different winding taps are associated with different impedance values such as 4 ohms, 8 ohms, and 16 ohms.

The dual parallel matching transformer subsystem 602 is illustrated in two sections: a first section for the first matching transformer T1A and a second section for the second matching transformer T1B. As indicated, the coils are connected in parallel, where Primary A taps of T1A (denoted here by colors: Green, Yellow, Black, and Brown) are connected to respective Primary B taps of T1B (denoted here by the same colors: Green, Yellow, Black, and Brown). Parallel connectivity shows that like colored taps on the two primaries and two secondaries are connected. Accordingly, Secondary A taps of T1A (denoted here by colors: Green, Yellow, Black, and Brown) are connected to respective Secondary B taps of T1B (denoted here by the same colors: Green, Yellow, Black, and Brown). This operation applies to FIG. 3 as well.

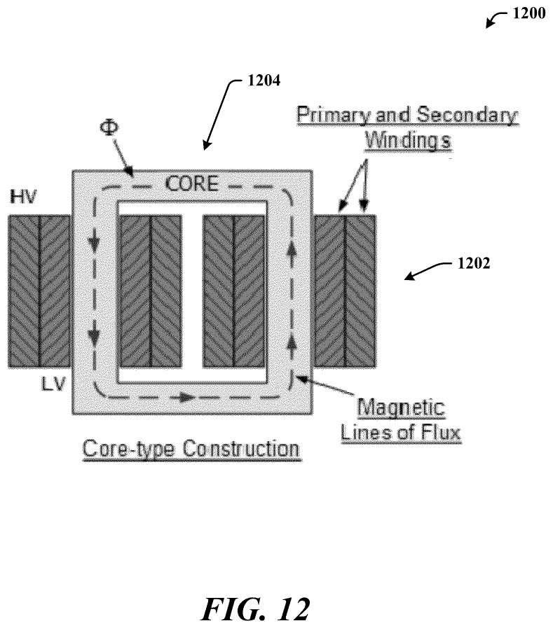

As also shown in FIG. 12, both sections represent the primary and secondary coil sets, and as shown in FIG. 12, each coil set mounted on a dedicated leg of the flatpack core configuration. The coils are arranged such that the radiated magnetic fields self-cancel can be minimized to an acceptable level or can even be eliminated entirely.

Associated with the matching transformers 602 are primary relays (RY12, RY13, and RY14) and corresponding secondary relays (RY17, RY15, and RY16). Bypass relays RY12 and RY17 are provided and controlled to operate in Mode A (bypass the transformer) or Mode B (transformer remains active, and LEDS blink). Relays RY13 and RY15 are provided and controlled to switch between 8-ohm and 16-ohm impedances, and relays RY14 and RY16 are provided and controlled to switch between 8-ohm and 4-ohm impedances. Example models for the relays RY12-RY17 can be G2RL-1-DC12 @ 2.03/500 SPDT NO 12A or G2RL-1-HA DC12 @ 1.94/500 SPDT NO 12A.

As indicated, the toggled wipers of relays RY12 and RY17 can both be controlled (by the onboard controller) into bypass Mode A when connecting the C2-C1 contacts of both relays, thereby bypassing the transformer subsystem 602. Accordingly, the signal pathway is defined by the signals entering from the switched/unswitched attenuator loop signal pathway(s) (Node B, as depicted and described in FIG. 7), connecting through the bypass relays RY12 and RY17 C2-C1 pathways to one or more of the speaker cabinet output connections (Node C, as depicted and described in FIG. 7).

When automatic impedance matching needs to occur, the pathway through relays RY12 and RY17 occurs along the connection defined by contacts C2-C3, which enables the transformer operation to assess an impedance match for the amplifier and speaker.

It is to be appreciated that operation of the automatic switcher section can be controlled by the controller (without user intervention (“handsfree”)) to quickly assess instances of impedance match (and enter transformer bypass mode), and impedance mismatch (keep the transformer active after determining the matched impedance settings).

The controller controls the relays RY12-RY17 via associated control points designated on the controller chip. For example, control point CT_XFMR_BP operates both relays RY12 and RY17, control points CT_PRI_16-8_RLY and CT_SEC_16-8_RLY operate corresponding relays RY13 and RY15, and control points CT_PRI_8-4_RLY and CT_SEC_8-4_RLY operate corresponding relays RY14 and RY16.

CT_PRI_16-8 is intended to mean the transformer primary toggle connection (relay control) between the 8 ohm and 16 ohm primary taps. Similarly, CT_PRI_8-4 is intended to mean the transformer primary toggle connection between the 4 ohm and 8 ohm taps. In a similar notation, CT_SEC_16-8 is intended to mean the transformer secondary toggled connection of the 8 ohm and 16 ohm taps, and CT_SEC_8-4 is intended to mean the transformer secondary toggle connection between the 4 ohm and 8 ohm secondary taps.

FIG. 7 illustrates a circuit diagram 700 as relates to block 228 of FIG. 2 in accordance with the disclosed architecture. The diagram 700 enables the connection of speaker cabinets to the automatic switcher system for impedance testing, selection, and operation. The diagram 700 comprises four relays: RY18-RY21. As shown, Node C in FIG. 7 is the same Node C in FIG. 6, which carries signals associated with the bypass Mode A or remain active Mode B, as described above. Relays RY18-RY21 are controlled by the onboard controller shown in block 238 of FIG. 2.

The control points CT_CAB_1, CT_CAB_2, CT_CAB_3, and CT_CAB_4, are controlled to activate one or more of the relay solenoids, when needed. Accordingly, when the speaker cabinets are cabled (connected) to the connector receptacles CAB_1-CAB_4, activating a relay solenoid via a control point, completes the signal pathway from the instrument signals to the speaker cabinet(s) having the compatible impedance(s) for the selected amplifier(s).

Node D of FIG. 7 is the same circuit point of Node D of FIG. 8. Node D relates to the switched/unswitched attenuator loops (blocks 222 and 224 of FIG. 2). The controller can exercise the GROUND LIFT wipers (2 and 5) of Switch S3 via a controller contact ISO_GND to ensure Node D can be an isolated ground relative to the ground at Node D of FIG. 7. Relays RY18-RY21 can be G2RL-1-DC12 @ 2.03/500 SPDT NO 12A or G2RL-1-HA DC12 @ 1.94/500 SPDT NO 12A, for example.

FIG. 8 illustrates a circuit diagram 800 as relates to the switched attenuator loop circuits 224 and unswitched attenuator loop circuits 222 of FIG. 2, in accordance with the disclosed architecture. As indicated, Node A of FIG. 5 is the same point as Node A of FIG. 8. Similarly, Node B of FIG. 8 is the same point as Node B of FIG. 6. Still further, Node D of FIG. 8 is the same point as Node D of FIG. 7.

As indicated with FIG. 5, one or more of the amplifier outputs plugged into the AMP RETURN receptacles, can be selected for the unswitched attenuation loop 802 or the switched attenuator loop 804. The insertion of an attenuator into the ATT LOOP 1 SND and LOOP 1 RET receptacles allows a user to insert a power attenuator between the amplifier buss (the circuit points common to NODE A, of FIG. 5) and the speaker buss (e.g., the circuit points common to respective speaker plugs of the receptacles via relays R18-RY21 of FIG. 7). Relays RY10-RY11 can be G2RL-1-DC12 @ 2.03/500 SPDT NO 12A or G2RL-1-HA DC12 @ 1.94/500 SPDT NO 12A, for example.

FIG. 9 illustrates a circuit diagram 900 for a remote capability for automatic switching in accordance with the disclosed architecture. The diagram relates to Block 232 of FIG. 2, and shows two remote switch functions: REM SW 1 and REM SW 2. The onboard controller (block 238 of FIG. 2) can send control signals to external devices connected to the system according to two contacts: CT_REM1 using a solenoid switch RY22, and CT_REM2 using a solenoid switch RY23. When CT_REM1 point is controlled to a lower voltage, the coil is energized causing the RY22 wiper to be toggled to the alternate position, which then enables external control of any device plugged into receptacle J20.

When the CT_REM2 point is controlled to a lower voltage, the coil is energized causing the RY23 wiper to be toggled to the alternate position, which then enables a QUICK_SWITCH function. The Quick-Switch function allows a predetermine microprocessor control function to be accessed by a single momentary external switching device plugged into receptacle J21. The quick switch circuit includes two quick switch controller points: CT_QS1 and CT_QS2, to provide direct access to microcontroller ports assigned for this purpose.

FIG. 10 illustrates additional circuits 1000 that can be employed in accordance with the disclosed architecture. For example, one or more circuits 1002 energize LED(s) which represent a matched impedance between an amplifier output and a speaker cabinet input. A circuit 1004 represents a controller capability to control a select/store function via a CT_SS controller contact. The circuit 1004 also represents a controller capability to control a quick-switch function select (QS_FUNCTION_SEL) via a CT_QSS controller contact. Circuit component chips J22 and J23 represent that MIDI chips can be employed for MIDI_IN and MIDI_THRU functionality.

FIG. 11 illustrates additional circuits 1100 that can be employed for LED indicator control in accordance with the disclosed architecture. The circuits relate to Block 236 of FIG. 2. The controller (or micro-controller) of Block 238 of FIG. 2, can be employed to control LED indicators associated with various operations and/or functions occurring during the automatic impedance switcher operations.

As shown, the micro-controller can control indicators associate with amplifier ohm status (AMP_4_OHM_IND, AMP_8_OHM_IND, AMP_16_OHM_IND) and speaker cabinets impedance status (CAB_4_OHM_IND, CAB_8_OHM_IND, CAB_16_OHM_IND), loop and auxiliary status (CT_AUX, CT_LOOP), amplifier relay status (CT_A1, CT_A2, CT_A3, CT_A4), controller contact states for cabinets (CT_CAB_1, CT_CAB_2, CT_CAB_3, CT_CAB_4), controller contact states for a remote (CT_REM1, CT_REM2), and MIDI contact learning state (CT_MIDI_LRN).

The controller unit(s) for controlling and manipulating pathways of various digital and/or analog signals can be one or more processing unit(s) (e.g., microprocessor(s), microcontrollers, etc.) and an onboard memory subsystem. The memory subsystem can comprise a computer-readable storage medium such as a non-volatile system memory, a storage subsystem of flash memory, and a bus system, for example. The controller(s) can be any of various commercially available microprocessors such as single-processor, multi-processor, single-core units and multi-core units of processing and/or storage circuits.

The controller(s) can be employed in support of cloud access and computing services. Cloud computing services, include, but are not limited to, infrastructure as a service, platform as a service, software as a service, storage as a service, desktop as a service, data as a service, security as a service, and APIs (application program interfaces) as a service, for example.

The memory subsystem can include computer-readable storage (physical storage) medium such as a volatile memory (e.g., random access memory (RAM), static RAM for caching, etc.) and a non-volatile memory (e.g., ROM, EPROM, EEPROM, etc.), for example. A basic input/output system (BIOS) can be stored in the non-volatile memory, and includes the basic routines that facilitate the communication of data and signals between components within the control system, such as during startup.

The bus system provides an interface for onboard system components including, but not limited to, the memory subsystem to the processing unit(s), and any wire/metal track interconnectivity between all modules such as a wired/wireless transceiver subsystem, operating system (OS) applications (Apps), software modules, data components, a power subsystem that provides power to all subsystems and components, and an I/O (input/output) subsystem which includes all I/O ports.

One or more application programs, program data, OS, and other software modules can be stored in the memory subsystem, a machine readable and removable memory subsystem. The operating system, one or more application programs, other program modules, and/or program data can include items and components of the controller system, for example.

Generally, programs include routines, methods, data structures, other software components, etc., that perform particular tasks, functions, or implement particular abstract data types. All or portions of the operating system, applications, modules, and/or data can also be cached in memory such as volatile memory and/or non-volatile memory of the memory subsystem, for example.

The storage subsystem and memory subsystem serve as computer readable media for volatile and non-volatile storage of data, data structures, computer-executable instructions, and so on. Such instructions, when executed by a computer or other machine, can cause the computer or other machine to perform one or more acts of a method.

Computer-executable instructions comprise, for example, instructions and data which cause a general-purpose computer, special purpose computer, or special purpose microprocessor device(s) to perform a certain function or group of functions. The computer executable instructions may be, for example, binaries, intermediate format instructions such as assembly language, or even source code. The instructions to perform the acts can be stored on one medium, or could be stored across multiple media, so that the instructions appear collectively on the one or more computer-readable storage medium/media, regardless of whether all of the instructions are on the same media.

Computer readable storage media (medium) exclude (excludes) propagated signals per se, can be accessed, and include volatile and non-volatile internal and/or external media that is removable and/or non-removable. The various types of storage media accommodate the storage of data in any suitable digital format. It should be appreciated by those skilled in the art that other types of computer readable medium can be employed such as zip drives, solid state drives, magnetic tape, flash memory cards, flash drives, cartridges, and the like, for storing computer executable instructions for performing the novel methods and processes of the disclosed architecture.

A user can interact with the controller program(s) and data using external user input devices as part of the I/O subsystem such as a keyboard and a mouse, as well as by voice commands facilitated by speech and image recognition. Other external user input devices (sensors) can include a microphone, an IR (infrared) remote control, a joystick, a game pad, camera recognition systems (e.g., gesture recognition, etc.), a stylus pen, touch screen, gesture systems (e.g., eye movement, voice control, body poses such as relate to hand(s), finger(s), body appendages such as arm(s), head, etc.), and the like. The user can interact with the programs and data using user input devices such a touchpad, microphone, keyboard, etc., where desired, for example.

These and other input devices are connected to the processing unit(s) through input/output (I/O) subsystem via the bus system, but can be connected by other interfaces such as a parallel port, IEEE 1394 serial port, a game port, a USB port, an IR interface, short-range wireless (e.g., Bluetooth) and other personal area network (PAN) technologies, etc. The I/O subsystem can also facilitate the use of output peripherals such as printers, audio devices, camera devices, and so on, such as a sound card and/or onboard audio processing capability.

The I/O subsystem can comprise one or more graphics interface(s) (also commonly referred to as a graphics processing unit (GPU)) provide graphics and video signals on a display and external display(s) and/or onboard displays (e.g., for portable computer). The graphics interface(s) can also be manufactured as part of a system board.

The disclosed controller system can operate in a networked environment (e.g., IP-based) using logical connections via the wired/wireless transceiver communications subsystem to one or more networks and/or other devices or computers. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, mesh networks and mesh nodes, all of which may connect to a global communications network such as the Internet.

When used in a networking environment the controller system can connect to the network via a wired/wireless transceiver communication subsystem (e.g., a network interface adapter, onboard transceiver subsystem, etc.) to communicate with wired/wireless networks, and other impedance switcher systems.

The controller system can be made operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), telephones, cell phones, smart phones and smart devices (e.g., smart TVs), for example. This includes at least Wi-Fi™ (used to certify the interoperability of wireless computer networking devices) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related technology and functions).

It is appreciated, however, that the some or all aspects of the disclosed methods and/or systems can be implemented in more compact technologies such as a SoC (system-on-a-chip), where analog, digital, mixed signals, and other functions are fabricated on a single chip substrate.

FIG. 12 illustrates a configuration of the flatpack matching transformer system 1200 (similar to dual parallel matching transformers 602) in accordance with the disclosed architecture. The dual parallel matching transformers 602 are constructed on a “flatpack” form factor, which form factor utilizes a “UI” core (in contrast to a conventional “EI” core).

Each core construction is composed of two parts: the main core structure that supports the coil(s), referred to as the U section 1202, and the end piece 1204 (or top piece in the figure) called the I section, which forms the closed core system.

In the conventional EI construction, all of the primaries and secondaries are wound around the center leg of the core comprised of the “E” shaped section, which results in a relatively square form factor that is cost effective to produce and is available in a variety of sizes to suit a wide range of power output handling capacities.

In contrast, in the UI construction, the primaries and secondaries can be wound separately and mounted on each leg of the two “U” section legs, or split up and combined as depicted. A drawback of the UI form is that it gets wider and longer as power handling capacity increases. To minimize size and maintain a stable sharing of the magnetic circuit between the two legs, two identical coil sets comprised of a primary and secondary are mounted on each leg of the U and are then connected in parallel to form one virtual coil.

In some applications of the UI design, this can cause electromechanical vibrations in the frequency range in which it is being operated. This can make low frequency operation, such as a 50/60 HZ AC line frequency, problematic for use in power transformers. These issues can be mitigated when used for audio: however, design engineers may avoid the UI form factor for audio due to the complexity of the design and assembly cost.

Though generally more costly and not generally considered ideal for use in audio output transformer designs, the UI construction has two distinct advantages over the EI construction:
1) The low profile of the construction of the part allows for a low-profile enclosure making it ideal for professional “rack mount” applications where higher power handling capacity is required, and vertical space is limited.
2) When two identical combined primary and secondary coils are arranged carefully on the legs, the coils tend to be self-cancelling in terms of radiated magnetic fields making them ideal for use in specialized audio applications.
3) Specific to this design, meaning that the switching component of the design ensures that the input amplitude of the transformer always equals the output amplitude, there will be no imbalance between the legs of the magnetic circuit, which will effectively eliminate electro-mechanical noise, allowing the transformer to well exceed the performance of a typical EI design.

Therefore, in spite of the expense and complexity of the design, the UI form factor together with the programmable switching aspect make possible the unusually compact and highly functional product design described here.

FIG. 13 illustrates an example front panel configuration 1300 (of controls and indicators) of the housing 202 of the disclosed switcher system variations in accordance with the disclosed architecture. The housing 202 can facilitate a rackmount design for mounting in compatible equipment racks. It is to be understood, however, that the system can be configured as a table top housing as well.

The front panel configuration 1300 can comprise an input port (or jack) 1302, an amplifier section 1304, an impedance section 1306, a speaker cabinet section 1308, and a control section 1310. The input jack 1302 enables insertion of a mating plug which carries the instrument signals to the impedance switcher. The amplifier section 1304 includes light indicators (e.g., LEDs) that indicate which of a number of (e.g., one or more) amplifiers (e.g., four amplifiers) can be selected for signal processing and/or amplification of the instrument signal.

The selection process is facilitated via the front-panel access by the user of push buttons: one push button for each of the amplifier systems connected to the disclosed switcher systems (e.g., FIG. 1, FIG. 2, FIG. 3, etc.), in this embodiment, up to and including four amplifiers which correspond to push buttons 1, 2, 3, and 4. That is, each push button (one of the input selects (INPUT SEL 1-4 of FIG. 4)) is provided to operate a relay (e.g., integrated, mechanical, and/or similar type of switching or latching device/circuit) to engage or disengage the associated amplifier impedance(s). For example, engaging buttons 1-3 of the amplifier section 1304, selects amplifiers 1-3 (AMP1, AMP2, AMP3 of FIG. 4) to receive the instrument signals for use in the automatic impedance matching switching process. Each of these three amplifiers can then output a different impedance, such as 4 ohms from AMP1, 8 ohms from AMP2, and 16 ohms from AMP3. The corresponding LEDs (LED1, LED2, and LED3) of the amplifier section 1304 then light for quick and easy perception by the user, such as when performing during a concert, etc. The LED circuitry is also depicted in FIG. 11.

The impedance section 1306, on the left side, comprises an amplifier (AMP) push button 1308, and three LED indicator lights for 4-ohm, 8-ohm, and 16-ohm amplifier output impedances. The impedance section 1306, on the right side, comprises a speaker cabinet (CAB) push button 1310, and three LED indicator lights for 4-ohm, 8-ohm, and 16-ohm cabinet input impedances. Thus, by engaging the AMP push button 1308, the amplifier(s) are connected through to the input side (primary side) of the internal matching transformers 602 (of FIG. 6). Similarly, by engaging the CAB push button 1310, the cabinet(s) are connected through to the output side (or secondary side) of the internal matching transformers 602 (of FIG. 6).

The front panel 1300 also includes a cabinet section 1312 which, in this embodiment, accommodates up to four speaker systems of various impedances (e.g., 4 ohms, 8 ohms, and 16 ohms), and corresponding push buttons for engagement of one or more speaker cabinets. That is, each push button (one of the CAB selects (CAB 1, CAB 2, CAB 3, CAB 4) of FIG. 7 is provided to operate a relay (e.g., integrated, mechanical, and/or similar type of switching or latching device/circuit) to engage or disengage the associated speaker cabinets system impedance(s).

For example, engaging buttons 1-3 of the cabinet section 1312, makes available cabinets 1-3 (CAB1, CAB2, CAB3 230 of FIG. 2) to receive the instrument signals processed through by the matching transformer according to the disclosed automatic impedance matching switching process. Each of these three cabinets can then receive a different impedance, as automatically determined by the disclosed automatic impedance switching architecture, such as 4 ohms for CAB1, 8 ohms for CAB2, and 16 ohms for CAB3. The corresponding LEDs (LED1, LED2, and LED3) of the cabinet section 1312 then light for quick and easy perception by the user, such as when performing during a concert, etc. The LED circuitry is also depicted in FIG. 11.

The front panel 1300 also includes a control section 1314 which, in this embodiment, allows the user to enable functions such as LOOP, EXT-1, EXT-2 and STORE, described elsewhere hereinabove. The LOOP functionality is described in FIG. 8, the EXT-1 and EXT-2 functionality is described in FIG. 9, and the STORE functionality is described in FIG. 10. Each of these functions has an associated push button to enable user action for engagement (push button in) or disengagement (push button relaxed or out).

In other words, disclosed herein is an impedance switcher system, comprising: a matching transformer subsystem, the subsystem comprises a matching transformer connected between amplifier outputs of differing output impedances and cabinet loads of differing load impedances, the transformer subsystem comprising; multiple primary-side taps where each primary-side tap connects to an amplifier output, which amplifier output has an amplifier output impedance which is different from amplifier output impedances of other amplifier outputs connected to the other primary-side taps; and multiple secondary-side taps where each secondary-side tap connects to a cabinet load, which cabinet load has a cabinet load impedance which is different from other cabinet load impedances of other cabinet loads connected to the other secondary-side taps; and a control system interfaced to the matching transformer subsystem to detect an impedance mismatch between the amplifier output impedances and cabinet load impedances, and at least one of connects the amplifier output impedances to equivalent load impedances, or bypasses the impedance matching process.

The control system is programmable and executes software instructions to automatically detect when an input on a primary-side and an output of the secondary-side are of an equivalent impedance value, and in response, bypasses the matching transformer subsystem. The control system is programmable and executes software instructions to automatically detect when an input on a primary-side and an output of the secondary-side are of different impedance values, and in response, enables the matching transformer subsystem to automatically connect an output system of an equivalent impedance value of the input system.

The control system is programmable and executes software instructions to automatically bypass the transformer subsystem to enable an impedance mismatch between an output device and an input device. The impedance switcher system can further comprise a processor-controlled relay switching subsystem connected to the transformer subsystem to store and execute stored configuration instructions related to detecting input/output device impedance mismatch and input/output device impedance equivalences.

The impedance switcher system can further comprise an external device loop which enables insertion of a power attenuator between an amplifier buss and a speaker buss, the external device loop is assignable and programmable for continuous operation or only on a specific signal path between an amplifier and a speaker cabinet. The external device loop enables use of an attenuator on a specific signal path which avoids the transformer subsystem. The impedance switcher system can further comprise a remote-control function which enables switching power on and off to the attenuator of the external device loop.

The impedance switcher system can further comprise a link function which enables electrical interconnection of multiple switcher systems for corresponding amplifier/speaker loads. The control system executes Bluetooth wired and wireless control protocols and MIDI wired and wireless control protocols. The impedance switcher system can further comprise a housing in which are mounted the matching transformer, the control system, instrument input connection, amplifier inputs and outputs, speaker inputs and outputs, operational status indicators, and relay switching elements controlled to enable connections between the instrument, the amplifiers, the transformer, the speakers, and the control subsystem.

In yet another embodiment, disclosed herein is an impedance switcher system, comprising: an input for receiving an input signal from an input device, the input device having an output impedance and the input signal switchable to enable connection to at least one of a single pathway or multiple signal pathways to an output, the output for outputting an output signal to an output device, the output device having an input impedance; switching elements positioned between the input and the output to enable switching of the input signal to the output using the at least one of a single pathway or multiple signal pathways; a transformer comprised of multiple primary windings mapped to corresponding primary impedances and multiple secondary windings mapped to corresponding secondary impedances; a control subsystem which automatically controls switching elements to engage or disengage the transformer based on an impedance match or an impedance mismatch of a signal pathway between the input device relative to the same signal pathway of the output device; and an external device loop which enables insertion of an attenuator between an input device and an output device, the external device loop is assignable and programmable for at least one of continuous operation or only on a specific signal path between the input device and the output device.

The impedance switcher system can further comprise a remote-control function which enables remotely switching power on and off to the attenuator of the external device loop. The impedance switcher system can further comprise a link function which enables electrical interconnection of multiple switcher systems for corresponding amplifier/speaker loads. The impedance switcher system can further comprise a control function stored and executed by the control subsystem in response to receipt of a switch closure of an external switching device connected for direct access to controller ports.

In still another embodiment, disclosed herein is an impedance switcher system, comprising: a matching transformer subsystem, the subsystem comprising a matching transformer connected between amplifier outputs of differing output impedances and cabinet loads of differing load impedances, the transformer subsystem comprising; multiple primary-side taps where each primary-side tap connects to an amplifier output, which amplifier output has an amplifier output impedance which is different from amplifier output impedances of other amplifier outputs connected to the other primary-side taps; and multiple secondary-side taps where each secondary-side tap connects to a cabinet load, which cabinet load has a cabinet load impedance which is different from other cabinet load impedances of other cabinet loads connected to the other secondary-side taps; and a control system interfaced to the matching transformer subsystem to detect an impedance mismatch between the amplifier output impedances and cabinet load impedances, and connect the amplifier output impedances to equivalent load impedances or bypass the impedance matching process, the control system is programmable and executes software instructions to automatically detect impedance equivalences and impedance mismatch.

The impedance switcher system can further comprise a processor-controlled relay switching subsystem connected to the transformer subsystem to store and execute stored configuration instructions related to detecting input/output device impedance mismatch and input/output device impedance equivalences. The impedance switcher system can further comprise an external device loop which enables insertion of a power attenuator between an amplifier buss and a speaker buss, the external device loop is assignable and programmable for continuous operation or only on a specific signal path between an amplifier and a speaker cabinet, wherein the external device loop enables use of an attenuator on a specific signal path which avoids the transformer subsystem.

The impedance switcher system can further comprise a remote-control function which enables switching power on and off to the attenuator of the external device loop. The control system is configured to execute Bluetooth wired and wireless control protocols and MIDI wired and wireless control protocols.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An impedance switcher system, comprising:
an audio signal interconnection subsystem electrically connected between power amplifiers and speakers to conduct musical instrument signals from the power amplifiers to the speakers, the power amplifiers have output impedances and the speakers have input impedances;
a transformer subsystem of primary-side taps and secondary-side taps, the primary-side taps electrically connect to respective amplifier outputs of the power amplifiers and the secondary-side taps electrically connect to respective speaker inputs of the speakers, the amplifier outputs each have different amplifier output impedances and the speaker inputs each have different speaker input impedances; and
a control system electrically interfaced to the transformer subsystem to detect an impedance mismatch between an amplifier output impedance and speaker load impedance, and in response, at least one of connects the amplifier output impedance to an equivalent load impedance or bypasses the impedance matching process.

2. The impedance switcher system of claim 1, wherein the control system is programmable and executes software instructions to automatically detect when an output impedance on a primary-side and an input impedance of the secondary-side are of an equivalent impedance value, and in response, bypasses the transformer subsystem.

3. The impedance switcher system of claim 1, wherein the control system is programmable and executes software instructions to automatically detect when an output impedance on a primary-side and an input impedance of the secondary-side are of different impedance values, and in response, enables the transformer subsystem to automatically connect a system output of an equivalent impedance value of a system input.

4. The impedance switcher system of claim 1, wherein the control system is programmable and executes software instructions to automatically bypass the transformer subsystem to enable an impedance mismatch between a power amplifier and a speaker, and which mismatch settings and associated electro-mechanical behavior of the speaker and associated back-EMF are fed back to the amplifier to impact a negative feedback loop.

5. The impedance switcher system of claim 1, further comprising a processor-controlled relay switching subsystem connected to the transformer subsystem to store and execute stored configuration instructions related to detecting input/output device impedance mismatch and input/output device impedance equivalences.

6. The impedance switcher system of claim 1, further comprising an external device loop which enables insertion of a power attenuator between an amplifier buss and a speaker buss, the external device loop is assignable and programmable for continuous operation or only on a specific signal path between a power amplifier and a speaker.

7. The impedance switcher system of claim 6, wherein the external device loop enables use of the power attenuator on a specific signal path, which power attenuator enables avoidance of the transformer subsystem.

8. The impedance switcher system of claim 6, further comprising a remote-control function which enables switching power on and off to the power attenuator of the external device loop.

9. The impedance switcher system of claim 1, further comprising a link function which enables electrical interconnection of multiple switcher systems for corresponding amplifier outputs and speaker loads.

10. The impedance switcher system of claim 1, wherein the control system executes Bluetooth wired and wireless control protocols and MIDI wired and wireless control protocols.

11. The impedance switcher system of claim 1, further comprising a housing in which are mounted the transformer subsystem, the control system, instrument input connection, amplifier inputs and outputs, speaker inputs and outputs, operational status indicators, and relay switching elements controlled to enable connections between the instrument, the amplifiers, the transformer, the speakers, and the control subsystem.

12. The impedance switcher system of claim 1, wherein each power amplifier is at least one of constructed to a nonconfigurable output impedance or enables a configurable output impedance.

13. The impedance switcher system of claim 1, wherein the control system activates switching elements to perform routing and impedance matching tasks according to combinations of at least one of user-selected control switch settings or system-detected control switch settings stored in non-volatile memory.

14. An impedance switcher system, comprising:
an audio signal interconnection subsystem electrically connected between power amplifiers and speakers to conduct musical instrument signals from the power amplifiers to the speakers, the power amplifiers have output impedances and the speakers have input impedances;
a transformer subsystem of primary-side taps and secondary-side taps, the primary-side taps electrically connect to respective amplifier outputs of the power amplifiers and the secondary-side taps electrically connect to respective speaker inputs of the speakers, the amplifier outputs each have different amplifier output impedances and the speaker inputs each have different speaker input impedances; and
a control system electrically interfaced to the transformer subsystem to detect an impedance mismatch between an amplifier output impedance and speaker load impedance, and in response, at least one of connects the amplifier output impedance to an equivalent load impedance or bypasses the impedance matching process, the control system activates switching elements to perform routing and impedance matching tasks according to combinations of at least one of user-selected control switch settings or system-detected control switch settings stored in non-volatile memory.

15. The impedance switcher system of claim 14, further comprising a remote-control function which enables remotely switching power on and off to the attenuator of the external device loop.

16. The impedance switcher system of claim 14, further comprising a control function stored and executed by the control subsystem in response to receipt of a switch closure of an external switching device connected for direct access to controller ports.

17. The impedance switcher system of claim 14, wherein the control system is programmable and executes software instructions to automatically bypass the transformer subsystem to enable an impedance mismatch between a power amplifier and a speaker, and which mismatch settings and associated electro-mechanical behavior of the speaker and associated back-electromotive force are fed back to the amplifier to impact a negative feedback loop.

18. An impedance switcher system, comprising:
a matching transformer subsystem, the subsystem comprising a matching transformer connected between amplifier outputs of differing output impedances and cabinet loads of differing load impedances, the transformer subsystem comprising;
multiple primary-side taps where each primary-side tap connects to an amplifier output, which amplifier output has an amplifier output impedance which is different from amplifier output impedances of other amplifier outputs connected to the other primary-side taps; and
multiple secondary-side taps where each secondary-side tap connects to a cabinet load, which cabinet load has a cabinet load impedance which is different from other cabinet load impedances of other cabinet loads connected to the other secondary-side taps; and
a control system electrically interfaced to the transformer subsystem to detect an impedance mismatch between an amplifier output impedance and speaker load impedance, and in response, at least one of connects the amplifier output impedance to an equivalent load impedance or bypasses the impedance matching process, the control system activates switching elements to perform routing and impedance matching tasks according to combinations of at least one of user-selected control switch settings or system-detected control switch settings stored in non-volatile memory.

19. The impedance switcher system of claim 18, further comprising a processor-controlled relay switching subsystem connected to the transformer subsystem to store and execute stored configuration instructions related to detecting input/output device impedance mismatch and input/output device impedance equivalences.

20. The impedance switcher system of claim 18, further comprising an external device loop which enables insertion of a power attenuator between an amplifier buss and a speaker buss, the external device loop is assignable and programmable for continuous operation or only on a specific signal path between an amplifier and a speaker cabinet, wherein the external device loop enables use of an attenuator on a specific signal path which avoids the transformer subsystem.
